(19) United States
(12) Patent Application Publication
(10) Pub. No.: US 2003/0040960 A1
(43) Pub. Date: Feb. 27, 2003

(54) Method for promoting online advertising

(76) Inventor: Eduardo Enrique Eckmann, Charlotte, NC (US)

Correspondence Address: Eduardo E. Eckmann, 9652 Whitewood Trail, Charlotte, NC, 28269, US

(21) Appl. No.: 09/934,434

(22) Filed: Aug. 22, 2001

(51) Int. Cl. G06F 17/60

(52) U.S. Cl. 705/14; 463/25

(57) ABSTRACT

A system and method which increases the attention of Internet users to ads displayed on web pages. The system randomly displays a modified ad giving the user that notices it, the chance to win a prize. The system involves a set of processes to create the web pages with random modified ads and to handle the client request.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

The present invention addresses a variety of problems that the online advertising industry is facing in their ability to justify their prices and attract brick-and-mortar companies to advertise with them.

The most common way of online advertising is through the use of ads, which are graphics that are displayed within the web pages along the content that the users are interested on. Ads have evolved from boring to exciting, from static to dynamic, from generic to user targeted, from one size, shape and place to many sizes, shapes and places. Still, people are not paying much attention to them.

The way online advertising companies measure their efficiency and set their pricing structure is by the number page views and the calculated values of: CPM, CPC and CTR. Sometimes the term “hits” is used inaccurately. Loading a single web page can generate many “hits” to the web server. The HTML, along with every graphic on the web page generates a request to the server (“a hit”). For advertising purposes the number of hits is not as important as the number of page views. The number of page views a site generates during a period of time multiplied by the average number of ads per page represents how many ads it can display. Web advertising companies need to know how many page views are generated per month to estimate how many ads can be sold in a month. CPM means Cost Per Thousand impressions and CPC means Cost Per Click. Both of these terms are used extensively when buying and selling advertising. There are two basic ways that ads are sold—these are either per impression or per click. Per impression advertising means that the amount paid is based on how many times an ad is displayed on the site. When selling/buying ad impressions, rates are always given in CPM. So $6 CPM would mean that the advertiser would get $6 for every thousand ads shown. Today, typical CPM rates range from $1 CPM to $10 CPM. Per Click advertising means that an amount of money is paid whenever a visitor clicks on that particular ad. Per Click rates are given in CPC. Currently, typical CPC rates range from $0.10 CPC to $0.60 CPC, and click through ratios (CTR) are between 0.5% and 1%. So, for 1,000 impressions, at 1% CTR and $0.60 CPC, the advertiser would get $6. For the last few years, CPM and CPC rates have been dropping as well as the CTR.

A large percentage of online advertisers are Internet companies expecting people to click on their ads and buy their products on the fly. These companies, in average, do not generate enough business out of their advertising expectations. Recently, web advertising companies have tried to attract more brick-and-mortar companies by selling them the benefits of branding online. Branding is about creating a good name and a memorable logo for a business. By including the company's logo onto all of its ads and getting them in front of as many people as possible, it is possible to advertise a product and create brand awareness at the same time. Companies willing to create branding rather than trying to sell something instantly, are more likely to use CPM. These companies would not expect people to click on the ads but to see them. Unfortunately for web advertising companies, it is difficult to demonstrate the effectiveness of these ads without considering the number of clicks.

In the early stages of the Internet, everything was new and one way to discover things was through looking at the ads. Today, people have identified the websites where they buy things, access their accounts, and do other activities. People know where in the page is the content they are looking for and focus on it. Also, most web advertisers are using the Internet Wait Time to display ads. With the advent of fast Internet access (DSL, CABLE, T1), the expected response time is much smaller, leaving the user with less time to spend looking at the ads on the page.

Many companies have developed software that filter ads and content from web pages following the user configuration. Examples of these companies are: AdSubtract, interMute, JunkBuster, Ad Filter, WebWasher, between many others. According to recent studies, there are more than 8 million copies of this software downloaded over the Internet and growing rapidly.

What is needed, therefore, is a process or mechanism, which creates an interest on the people to see the ads.

### BRIEF SUMMARY OF THE INVENTION

As most Internet users avoid looking at the ads displayed on web pages along the content that they are interested in. There have been many attempts to solve the problem by displaying bigger ads, changing ad locations, and using pop-under ads. None of these have solved the problem. The invention involves a system and method which increases the attention of Internet users to ads displayed on web pages. The system randomly displays a modified ad giving the user that notices it, the chance to win a prize. This method is particularly important to the online advertising companies that are trying to sell the concept of branding and capture more brick-and-mortar customers.

### BRIEF DESCRIPTION OF THE SEVERAL VIEWS OF THE DRAWING

This invention is best described with reference to the included drawings, which are intended to illustrate and not to limit the invention, and in which:

FIG. 1 is an illustration of an original sample ad and four examples of lucky ads. A lucky ad is the original one with any type of modification applied to it.

FIG. 2 is a flow diagram illustrating the process of creating a web page that makes people want to see the ads before than the user content.

FIG. 3 is a flow diagram illustrating a process to insert on the web page an ad with lucky sign option.

FIG. 4 is a flow diagram illustrating a sample process to replace one or more ad images and destination URLs available in a directory or repository. This process runs independently of any user interaction.

FIG. 5 is a flow diagram illustrating a sample process to handle a client request. This process gets executed when the user finds the lucky ad and makes a click following the instructions of the program.

### DETAILED DESCRIPTION OF THE INVENTION

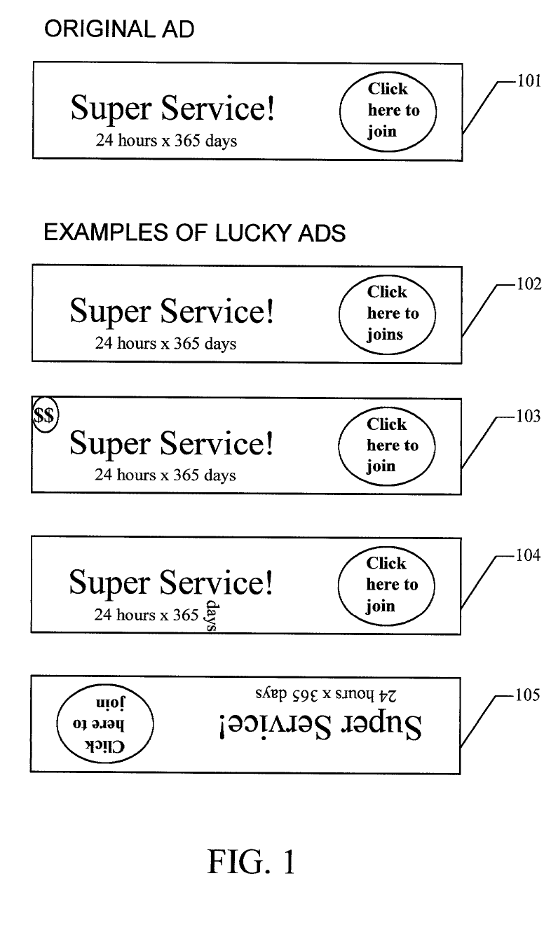

The present invention involves a group of processes for increasing the attention of Internet users to web ads by randomly displaying a modified ad called “lucky ad”. In FIG. 1, an example of an original ad 101 is modified in four different ways: 102 says “joins” instead of “join”, 103 has a “lucky symbol”, 104 has “days” vertically and 105 is up-side-down. These are just examples and by no means limit the ways in which an ad can be modified. If the user notices the change and follows the instructions of the program, such as clicking on the ad, the user enters the sweepstake.

There are two main stages involved in this invention: construction and manipulation. Construction refers to all the activities related to creating the web page with the option to contain a lucky ad. The random algorithm can be embedded within the creation of the dynamic page or executed within an external software that runs periodically or constantly. Manipulation involves handling the request generated by a user click.

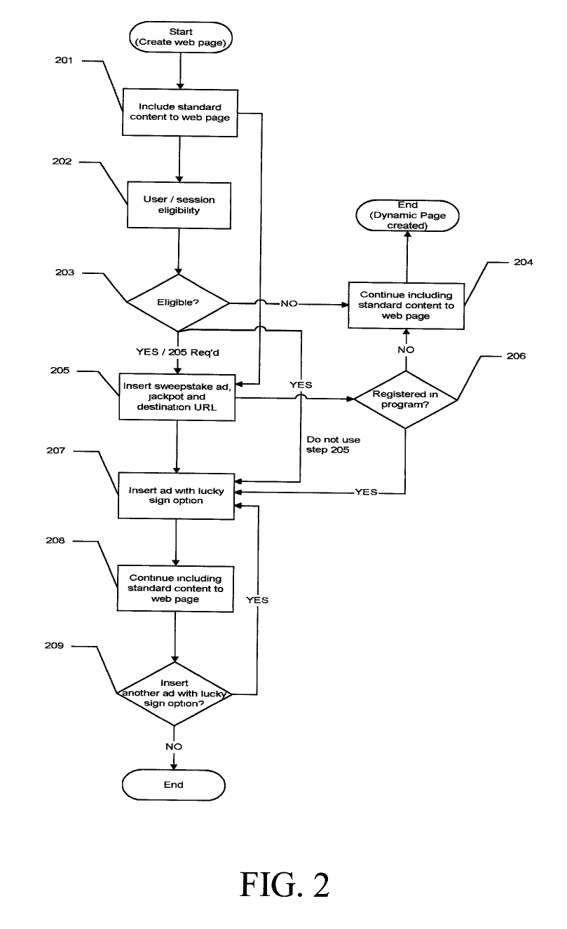

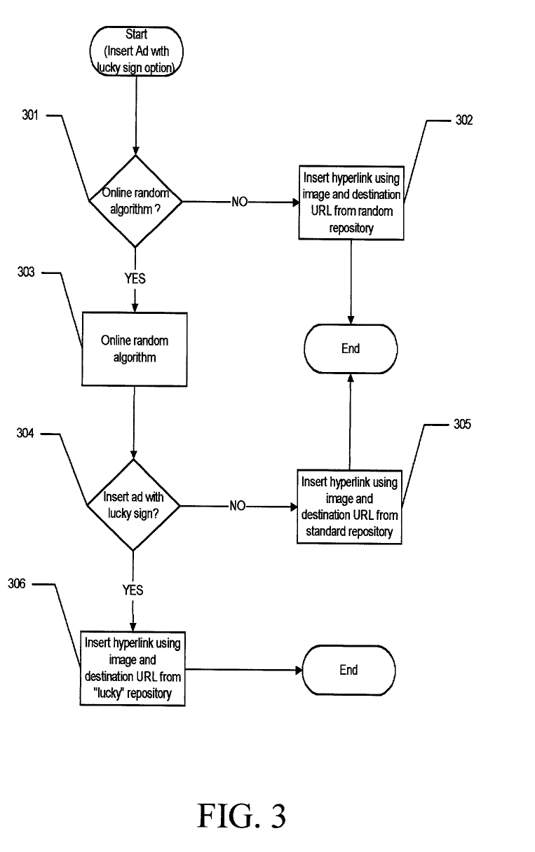

FIG. 2 illustrates the process of creating a web page with option to lucky ads and advertising to the “lucky ad” sweepstake program. As with any web page, step 201 includes standard elements to the web page, such initial HTML tags, javascript and even some standard user content. Step 202, is optional and verifies if the user is eligible to participate in the program. For example, the program rules might require participants to be at least 18 years old and it might apply for a specific country. If the answer obtained in 202 is that the user is not eligible, step 203 will route the flow to step 204 which continues to include standard content to the web page without mention to the “lucky ad” sweepstake program. If the answer was true, the flow moves to the optional step 205, which will include an advertisement to the program. As a way to keep users motivated to the program, the ad can display the current sweepstake jackpot, which can be expressed in any currency, points, miles, or any type of prizes. This ad, can also involve a hyperlink to the home page of the program, where the user can find the link to the registration web page (if it exists), and general information such as the rules of the program, past winners, program sponsors, etc. If registration to the program is required, the flow will continue with step 206, where registration is verified. If the answer is not, the flow moves to step 204 described above. If the user is registered or registration is not required, the process moves to step 207, “insert ad with lucky sign option”, described in detail in FIG. 3. After this step, the flow continues to include standard content, step 208 and if there are additional ads with lucky sign option, step 209 will re-route the flow back to step 207 until there are no more ads with lucky sign option.

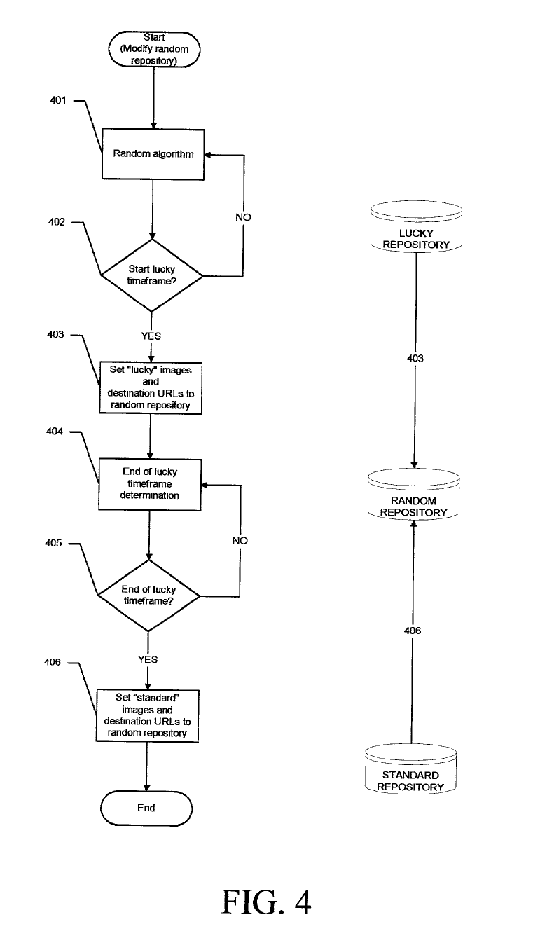

FIG. 3 is a flow diagram illustrating a process to insert on the web page an ad with lucky sign option. The random algorithm that determines if the page will include a lucky ad, can be run within this sub-Process or be done independently of the page creation by the process illustrated in FIG. 4, described below. Step 301 defines which of the two methods will be used. If the random algorithm is not executed online, the flow moves to step 302, which will insert a hyperlink using image(s) and destination URL from a random repository (for more information on random repository, see description of FIG. 4). If the answer to step 301 is true, the flow moves to step 303, which executes a random algorithm based on parameters provided by the site implementing the “lucky ad sweepstake program”. The result of 303 is evaluated in step 304. If the ad will to be inserted is not a lucky ad, step 305 will insert a hyperlink using image(s) and destination URL from the standard repository, otherwise step 306 will do the same but utilize image(s) and destination URL from the lucky repository. Steps 302, 305 and 306 are final steps before returning to the web page creation process.

The random algorithm determines if the user will get a lucky ad. In this case the possible answers are true or false. But if the answer is true, the algorithm can also provide the magnitude of the prize which can be represented by a different symbol embedded in the image. For example, if the result of the algorithm is a four digit positive integer number, results between 0-9899 might represent a standard image without symbol, 9900-9989 can represent an image with the symbol “$”, 9990-9998 with “$$” and 9999 with“$$$”.

FIG. 4 illustrates a process: that modifies the images and destinations URLs of the random repository. The process can be continuously running or executed for periods of time. A repository is a place where files such as images and text can be stored. Usually it will be a file directory with a URL. Three types of repositories are identified: the standard repository, which contains all standard images and destination URLs that do not involve a lucky sign; the lucky repository, in which all images and destination URLs include a lucky sign and the random repository, which most of the time is a replica of the standard repository, but for short periods of time, these images and URLs are changed for the ones available in the lucky repository. The process starts with step 401 which is a random algorithm that identifies if this is the start of a lucky timeframe and if so, it determines which are the images that should be replaced in the repository. As soon as step 401 provides a true for answer, step 402 will move the flow to step 403 in which the “lucky” images and destination URLs will be set on the random repository. Step 404 will determine when is the end of the lucky timeframe. As soon as step 405 receives a true for an answer, the flow moves to step 406, in which the previously changed images are replaced back to the originals from the standard repository

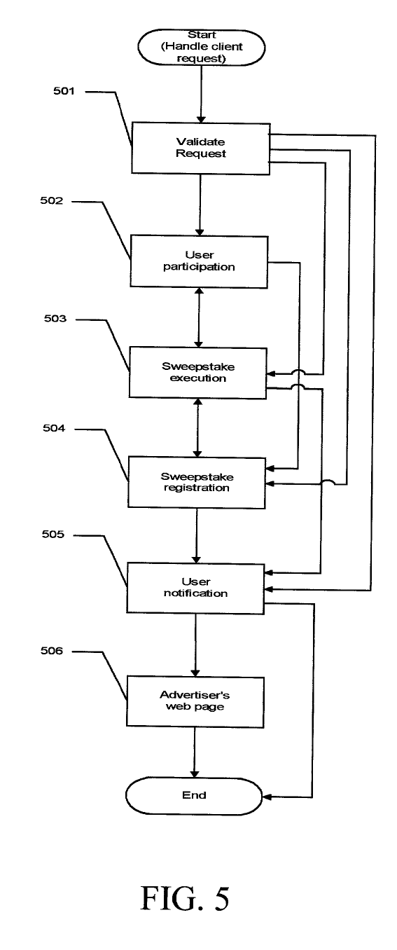

FIG. 5 is a flow diagram illustrating a sample process to handle a client request. This process gets executed when the user finds the lucky ad and makes a click following the instructions of the program. All of the steps within this process are optional with the exception of Request Validation (501) and User Notification (505). There is no pre-determined order or sequence in which the optional steps can be executed with the exception of the Advertiser's web page (506), which occurs last. The sub-process starts validating the request, step 501. This step involves verifying that the request is received within a specified timeframe since the page was displayed, validate security data embedded in the request, and it has not been processed yet. Another step, User participation (502) involves asking the user for information. This step can also be used to create a small user contest if it is a requirement to win the prize. Step 503, Sweepstake execution, involves the execution of a random algorithm to determine the prize for the user. Step 504, Sweepstake registration, is required if the sweepstake will occur at a later time. The client request gets registered for the sweepstake and most likely, the user will be informed by an e-mail. Step 505, User notification involves a web page that informs the user about the results of the sweepstake or sweepstake registration. The page should also contain information such as “No purchase required”, “only valid on the states or countries where does not break the law”, etc. The last step in this process is 506, Advertiser web page. After the notification, the user will get the advertiser web page displayed.

The present invention may be better understood by reference to a number of commonly used terms, definitions of which are as follows:

The term “ad”, as used herein, refers to an advertising image displayed in a web page.

The term “advertiser”, refers to the Company paying for advertisement.

The term “advertising company” refers to the entity who provides and charges for advertisement.

The term “lucky ad”, refers to an ad that has been modified and offers the user the chance to win a prize.

The term “prize”, refers to anything that can be given as an award, for example: points, miles, credits, an entry to a sweepstake, a car.

The term “program”, refers to a system, or offering that might require enrollment for user participation.

The term “sign” refers to a symbol or any graphic or modification to a graphic.

The term “sweepstake”, refers to a promotional effort to promote one or many products in which there is a chance to win a prize but there is no consideration. For this, an alternative method of entry is required (e.g. entry by mail).

What is claimed is:

1. A process for increasing the attention of Internet users to the ads displayed on web pages, comprising the step of:
Randomly displaying on a web page a modified ad and destination URL, giving the user a chance to win a prize.

2. A process as set forth in claim 1, including the step of:
Verifying user and/or session eligibility to the program.

3. A process as set forth in claim 1, including the step of:
Inserting a sweepstake ad, jackpot and destination URL.

4. A process as set forth in claim 2, including the step of:
Inserting a sweepstake ad, jackpot and destination URL.

5. A process for processing or handling the client request generated by a user click. The process comprises the steps of:
Validating the request
Notifying the user.

6. A process as set forth in claim 5, including the step of:
Requesting and handling user participation.

7. A process as set forth in claim 5, including the step of:
Executing sweepstake.

8. A process as set forth in claim 5, including the step of:
Registering entry into sweepstake.

9. A process as set forth in claim 5, including the step of:
Displaying advertiser's web page.

10. A process as set forth in claim 6, including the step of:
Executing sweepstake.

11. A process as set forth in claim 6, including the step of:
Registering entry into sweepstake.

12. A process as set forth in claim 6, including the step of:
Displaying advertiser's web page.

13. A process as set forth in claim 7, including the step of:
Registering entry into sweepstake.

14. A process as set forth in claim 7, including the step of:
Displaying advertiser's web page.

15. A process as set forth in claim 8, including the step of.
Displaying advertiser's web page.

16. A process as set forth in claim 10, including the step of:
Registering entry into sweepstake.

17. A process as set forth in claim 10, including the step of:
Displaying advertiser's web page.

18. A process as set forth in claim 11, including the step of:
Displaying advertiser's web page.

19. A process as set forth in claim 17, including the step of:
Displaying advertiser's web page.

20. A process as set forth in claim 16, including the step of:
Displaying advertiser's web page.
